(19) United States
(12) Patent Application Publication
(10) Pub. No.: US 2009/0204240 A1
(43) Pub. Date: Aug. 13, 2009

(54) CNC CONTROLLER AND METHOD FOR DATA TRANSMISSION

(76) Inventor: Abderrahim Ait Yacine, Michelstadt (DE)

Correspondence Address: STRIKER, STRIKER & STENBY, 103 EAST NECK ROAD, HUNTINGTON, NY, 11743, US

(21) Appl. No.: 12/365,964

(22) Filed: Feb. 5, 2009

(30) Foreign Application Priority Data
Feb. 11, 2008 (DE) 10 2008 008 646.0

(51) Int. Cl. G05B 19/18; G06F 12/00

(52) U.S. Cl. 700/87; 700/159; 711/115; 711/103; 710/300

(57) ABSTRACT

A CNC controller for a machine tool has a read/write device for use with an interchangeable memory unit for storing and loading machine data, it being possible to act on the read/write device using an interchangeable memory unit, and the CNC controller being set up to transfer machine data to an interchangeable memory unit which is connected to the read/write device, or from an interchangeable memory unit which is connected to the read/write device, and a method provides transferring data between a CNC controller for a machine tool and an interchangeable memory unit.

### CROSS-REFERENCE TO RELATED APPLICATION

The invention described and claimed hereinbelow is also described in German Patent Application DE 10 2008 008 646.0 filed on Feb. 11, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a CNC controller for machine tools, a method for transferring data between a CNC controller for a machine tool and an interchangeable memory unit, a related computer program, and a related computer program product.

Even today setting or parametrizing a CNC controller requires a substantial amount of time. To start up a CNC controller, it must be programmed and parametrized, which requires that machine parameters, drive parameters, files in a RAM, files in a ROM, tool tables, system data, CPL and SPC variables, etc., must be programmed and set. In the prior art, it is particularly problematic to archive previously-entered settings for use in subsequent repeat production runs or to transfer them to other CNC controllers.

Today, it is not possible to transfer all of the machine data mentioned above, and a properly prepared PC must be connected to the CNC controller in order to archive and eventually back-up the data. The operator requires strong technical knowledge in order to perform the data transfer, and the operator must be aware of the compatibility requirements of various CNC controllers and various archives. The operator must manually select the data to be stored, and then store it in individual files in a conventional manner.

### SUMMARY OF THE INVENTION

Based on this background, the present invention provides a CNC controller for machine tools, a method for transferring data between a CNC controller for a machine tool and an interchangeable memory unit, a related computer program, and a related computer program product, which are further improvements of existing solutions.

It is therefore an object of the present invention to provide a CNC controller and a method for data transmission, which are improvements of the existing devices and methods.

The present invention makes it possible, in a simple and, in particular, user-friendly manner, to archive data from a CNC controller or to transfer them to other CNC controllers, in particular, to “clone” fully configured CNC controllers. Using the solution according to the present invention, archiving and data transfer may be carried out easily using interchangeable memory units or media, without the need for specially set-up computer systems. Sources of error in data transmission are reduced by storing the machine data on interchangeable memory units. It is advantageously possible to automatically generate complete records or archives of machine data on the interchangeable memory unit which is compatible with many other CNC controllers due to the completeness of the data.

The CNC controller is preferably set up in a manner such that, once the operator issues the release, a complete set of machine data that is sufficient to provide a machine configuration is automatically saved to the interchangeable memory unit. Likewise, the CNC controller is preferably set up in a manner such that, once the operator issues the release, a complete set of machine data that is sufficient to provide a machine configuration is automatically downloaded from the interchangeable memory unit.

Advantageously, an appropriate interface protocol is provided that enables CNC controllers according to the present invention to generate archives or memory files of all machine data that are required for an operation and a compatible transfer of data to other CNC controllers.

Particularly advantageously, the read/write device is designed as a USB interface. The USB interface is a standardized interface that is particularly robust and reliable. Moreover, a large number of interchangeable media for use with the USB interface already exists.

The interchangeable memory unit is expediently designed as a Flash memory with a USB interface, in particular as a “USB stick”. Flash memories are also particularly robust, reliable, and long-lived, thereby making them particularly suitable for use in a shop environment. It is also possible, of course, to use, e.g. external hard drives which include a USB interface or the like.

The machine data may be stored in a TAR file on the interchangeable memory unit. Using TAR, it is possible to write files sequentially to a single file, or to recreate files therefrom, which is particularly suitable for use in the application according to the present invention.

Expediently, the machine data include machine parameters, drive parameters, files in a RAM file system, files in a user EEPROM, tool tables, system data, and/or permanent SPC variables, in particular all data that are required to completely parametrize a CNC controller.

The present invention also relates to a computer program which includes program code means for implementing all steps of a method according to the present invention when the computer program is run on a computer or a related arithmetic unit, in particular on a CNC controller according to the present invention.

The computer program product—which is provided according to the present invention—comprising program code means which are stored on a computer-readable data storage device is designed to carry out all steps of a method when the computer program is run on a computer or a related arithmetic unit, in particular on a CNC controller according to the present invention. Suitable data storage devices are, in particular, diskettes, hard drives, Flash drives, EEPROMs, CD-ROMs, DVDs, etc. It is also possible for a program to be downloaded from computer networks (Internet, intranet, etc.).

Further advantages and embodiments of the present invention result from the description and the attached drawing.

It is understood that the features mentioned above and to be described below may be used not only in the combination described, but also in other combinations or alone, without leaving the framework of the present invention.

The present invention is depicted schematically with reference to an exemplary embodiment in the drawing, and it is described in detail below with reference to the drawing.

### BRIEF DESCRIPTION OF THE DRAWINGS

FIG. 1 is a schematic depiction of a preferred embodiment of a CNC controller according to the present invention.

### DESCRIPTION OF THE PREFERRED EMBODIMENTS

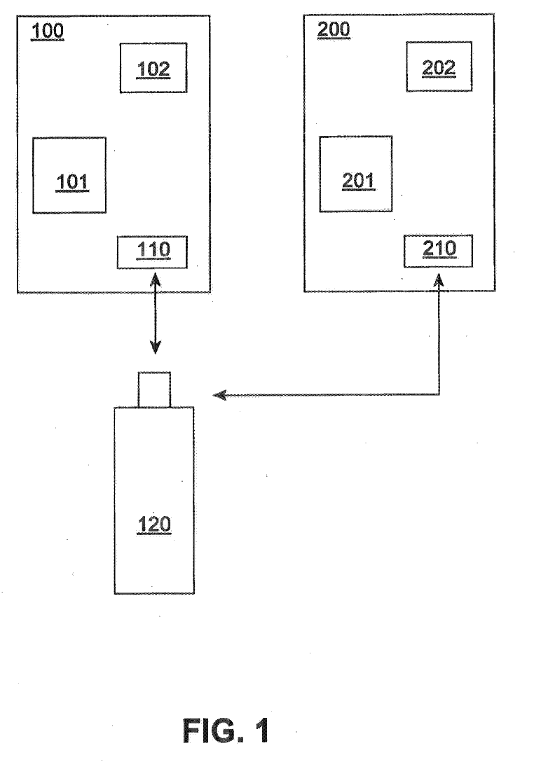

A preferred embodiment of a CNC controller according to the present invention for machine tools is labelled as a whole with reference numeral 100 in FIG. 1. CNC controller 100 includes a read/write device for interchangeable media, which is designed as a USB interface 110. Flash memory media which include a USB interface, in particular “USB sticks”, are used as the interchangeable media in the case of preferred CNC controller 100. SPC controller 100 also includes a memory 102 and a processing unit or CPU 101.

In a preferred embodiment of the method according to the present invention, a USB stick 120 is inserted into USB interface 110. CNC controller 100 recognizes connected USB stick 120 as an interchangeable memory unit and gives the operator the option, e.g. via the HMI, to store machine data in an archive file on USB stick 120. In the storage process, machine data which include machine parameters, drive parameters, files in a RAM file system, files in a user EEPROM, tool tables, system data, and/or permanent SPC variables are preferably stored in an archive file, preferably in compressed form. A TAR format may be used, for example, as the file format.

After the data have been stored, the user may remove USB stick 120 from USB interface 110. The machine data stored on the USB stick may now be used to configure other CNC controllers in a manner similar to CNC controller 100. For this purpose, USB stick 120 is inserted into a USB interface 210 of a second CNC controller 200. The SPC controller also includes a memory unit 202 and a CPU 201.

Second CNC controller 200 recognizes connected USB stick 120 and gives the operator the option, e.g. via the HMI once more, to load the data which are stored on USB stick 120. When the data stored on USB stick 120 are loaded, second SPC controller 200 preferably carries out the following steps.

The file which is stored on USB stick 120, e.g. a TAR file, is downloaded to a memory 202 of SPC controller 200. Next, the file which is now located in memory 202 is extracted, if necessary, and the machine data are now present in a form that may be read directly. CNC controller 200 now carries out a compatibility check of the machine data to ensure that the machine data are suitable for use by CNC controller 200. Finally, the machine data are written to the associated memory areas, so that they are available for the operation of CNC controller 200.

Analogously to the data transmission method described with reference to second SPC controller 200, it is possible to return the data stored on USB stick 120 to CNC controller 120 at a later time. In this application, USB stick 120 is used as a (long-term) memory unit, so that machine data that have already been configured will be available at a later point in time.

Using the above-described solution according to the present invention, it is possible to configure and reconfigure CNC controllers quickly and in a user-friendly manner.

It is understood that only one particularly preferred embodiment of the present invention is depicted in the figures shown. Any other type of embodiment is also feasible, without leaving the scope of the present invention.

It will be understood that each of the elements described above, or two or more together, may also find a useful application in other types of constructions and methods differing from the types described above.

While the invention has been illustrated and described as embodied in a CNC controller and a method for data transmission, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A CNC controller for a machine tool, comprising an interchangeable memory unit (120) for storing and loading machine data; and a read/write device provided for said interchangeable memory unit, said interchangeable memory unit and said read/write device being configured so that it is possible to act on said read/write device using said interchangeable memory unit, and the machine data are transferrable to said interchangeable memory unit which is connected to said read/write device, or from said interchangeable memory unit which is connected to said read/write device.

2. The CNC controller as defined in claim 1, wherein said read/write device is configured as a USB interface.

3. The CNC controller as defined in claim 1, wherein said interchangeable memory unit is configured as a Flash memory which includes a USB interface.

4. A method of transferring data between a CNC controller for a machine tool and an interchangeable memory unit connected to a read/write device of the CNC controller, the method comprising the steps of transferring machine data from the CNC controller to the interchangeable memory unit or from the interchangeable memory unit to the CNC controller.

5. The method as defined in claim 4, further comprising configuring the interchangeable memory unit as a Flash memory which includes a USB interface.

6. The method as defined in claim 4, further comprising storing the machine data in a TAR file on the interchangeable memory unit.

7. The method as defined in claim 4, further comprising including in the machine data elements selected from the group consisting of machine parameters, drive parameters, files in a RAM file system, files in a user EEPROM, tool tables, system data, permanent SPC variables, and a combination thereof.

8. A computer program comprising program code means for carrying out the steps of a method recited in claims 4, when the computer program is run on a computer or a related arithmetic unit.

9. A computer program comprising program code means for carrying out the steps of the method recited in claim 4 when the computer program is run on the CNC controller as recited in claim 1.

10. A computer program product, comprising product code means which are stored on a computer-readable data storage device, which is configured to carry out the steps of the method recited in claim 4 when the computer program is run on a computer or a related arithmetic unit.

11. A computer program product comprising program code means which are stored on a computer-readable data storage device which is configured to carry out the steps of the method as recited in claim 4 when the computer program is run on the CNC controller recited in claim 1.
